(19) United States
(12) Patent Application Publication
(10) Pub. No.: US 2026/0010584 A1
(43) Pub. Date: Jan. 8, 2026

(54) MACHINE LEARNING CLUSTERING OF TRAINING DATA FOR MODEL TRAINING OF CUSTOMIZED MACHINE LEARNING MODELS

(71) Applicant: ACTIMIZE LTD, Ra'anana (IL)

(72) Inventors: Sunny THOLAR, Pune (IN); Sumit KUMAR, Pune (IN); Ankush SHRIKHANDE, Pune (IN)

(21) Appl. No.: 18/766,227

(22) Filed: Jul. 8, 2024

(51) Int. Cl. G06F 18/23213; G06F 18/10; G06N 20/20

(52) U.S. Cl. CPC G06F 18/23213; G06F 18/10; G06N 20/20

(57) ABSTRACT

An autonomous machine learning (ML) system and methods are provided that are configured to intelligently cluster training data into separate training data sets for customized ML model training. The system includes a processor and a computer readable medium operably coupled thereto, the computer readable medium comprising a plurality of instructions stored in association therewith that are accessible to, and executable by, the processor, to perform model training operations which include accessing training data, determining a set of features used for the customized ML model training, clustering the training data into the separate training data sets according to the set of features, outputting the separate training data sets, training the plurality of ML models, packaging the plurality of ML models in individual data containers, and configuring the ML data processing platform with the individual data containers.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates generally to artificial intelligence (AI) and machine learning (ML) systems and models, such as those that may be used for anti-money laundering (AML) and fraud detection with financial institutions, and more specifically to a system and method for training multiple customized ML models for specific ML tasks using clustered training data.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized (or be conventional or well-known) in the prior art. The subject matter in the background section merely represents different approaches, which in and of themselves may also be inventions.

Financial crimes, such as money laundering, fraud, and other illicit activities, threaten the financial industry by undermining trust, integrity, and stability that users have in their financial institutions. These crimes may cause significant damages in both financial and reputational terms. Financial institutions have responded by implementing various risk management and investigation techniques to mitigate these risks. These require specific systems, departments, agents, and investigators to resolve and prevent such crimes, recover lost or stolen funds, and/or identify bad actors and fraudulent entities. However, fraud and money laundering schemes and techniques are constantly changing, and new strategies, vulnerabilities, or other techniques by which fraud or money laundering can be conducted and/or financial institutions exploited are constantly being identified by bad actors. As such, intelligent systems for automating fraud detection and prevention require more advanced and evolving techniques and solutions.

With advancements in AI technology, fraudsters have access to increasingly powerful tools and methods to orchestrate fraudulent activities. These technological advancements enable fraudsters to devise more intricate schemes that are difficult to detect using traditional methods. The rapid evolution of AI technology means that fraudsters can quickly adapt to security measures and fraud detection systems, often staying one step ahead of these detection systems. This dynamic landscape necessitates a proactive approach to fraud detection that can keep pace with the sophistication of fraudulent activities. In the past, fraud patterns may have been relatively standardized and predictable, making them easier to identify and mitigate.

However, with advancements in technology and the diversification of fraud tactics, the range of fraudulent activities has expanded significantly. Fraudsters now employ a variety of techniques, including identity theft, account takeover, phishing, social engineering, and other unique techniques to conduct fraudulent activities. The diversity in fraud patterns poses a significant challenge to traditional fraud detection systems, which may struggle to adapt to new and evolving threats. Using a single, static model for fraud detection across an entire population is therefore inherently limited in its effectiveness and ability to be applied to these diverse fraud patterns. Such a model may not be able to adequately capture the range of fraudulent behaviors exhibited by different individuals or groups. As a result, certain types of fraud may go undetected, leading to financial losses for financial institutions and other affected parties. The reliance on a one-size-fits-all approach to fraud detection fails to account for the nuanced variations in behavior and activity that may indicate fraudulent intent. As such, service providers may desire an AI-based model selection that allows for the customization of ML models for fraud detection to suit the specific needs and characteristics of different populations or segments. Thus, it is desirable to provide more customized and tailored ML models to specific ML tasks, and there is a need for improvements to ML models for fraud detection with specific data patterns and population subsets.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion. In the figures, elements having the same designations have the same or similar functions.

FIG. 1 is a simplified block diagram of a networked environment suitable for implementing the processes described herein according to an embodiment.

FIG. 2 is a simplified system architecture of a service provider that may utilize customized ML models trained from separate training data sets of clustered data according to some embodiments.

FIG. 3 is a simplified diagram for generating separate training data sets and training customized ML models for specific ML tasks and data patterns according to some embodiments.

FIG. 4 is a simplified diagram of customized ML model development based on clustered data according to some embodiments.

FIG. 5 is a simplified diagram of ML model selection for ML inferencing using customized ML models for specific ML tasks and data patterns according to some embodiments.

FIG. 6 is a simplified diagram of an exemplary flowchart for generating separate training data sets from ML clustering and training customized ML models using the data sets according to some embodiments.

FIG. 7 is a simplified diagram of a computing device according to some embodiments.

### DETAILED DESCRIPTION

This description and the accompanying drawings that illustrate aspects, embodiments, implementations, or applications should not be taken as limiting-the claims define the protected invention. Various mechanical, compositional, structural, electrical, and operational changes may be made without departing from the scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

A service provider, such as a customer relationship management (CRM) and/or fraud detection system and provider, may implement an intelligent ML framework that trains multiple ML models each on a different data set that has been clustered from a larger training data set. The clustered data may provide customized and unique data sets, which may correspond to groups of data (e.g., data records for transactions, users, accounts, profiles, etc.) that may have the same or similar characteristics (e.g., users sharing similar demographic information, transactions having similar amounts or items, etc.). The service provider may utilize clustering algorithms to segment a population of data points into distinct groups based on shared characteristics and behaviors. This segmentation allows the service provider to create more targeted and focused analysis by ML models, as the service provider may identify different groups exhibiting certain patterns of fraudulent activity. For example, a cluster representing elderly individuals may have different fraud behaviors compared to a cluster of young professionals. By understanding these nuances, the service provider can tailor fraud detection efforts to each group's specific characteristics. To tackle the diverse nature of fraud patterns within the population, the service provider may employ unsupervised clustering algorithms for data clustering. These algorithms analyze both static data (e.g., demographic information) and non-static data (e.g., transactional behavior) to identify groups or clusters with similar characteristics. By clustering individuals, entities, activities, and the like based on shared attributes, the service provider can effectively segment a population into distinct groups, each potentially exhibiting unique fraud patterns, behaviors, characteristics, activities, and the like. This clustering process lays the groundwork for tailoring fraud detection strategies to the specific characteristics and behaviors of each cluster.

Once the population is segmented, the service provider may then develop customized ML models for each group. These models may be trained using data specific to the behaviors and characteristics of the data within each respective cluster. Unlike traditional one-size-fits-all models, which may overlook unique fraud patterns and/or evolving fraud patterns within different segments, the tailored models are optimized to identify the specific indicators of fraud within each group. Once clusters are formed, the service provider may then proceed with developing customized ML models for each cluster, which creates unique models better tailored to the fraud characteristics of each cluster. By training models specifically for each cluster, the service provider may capture the subtle nuances and variations in fraud behavior that may exist within different segments of the population. This tailored approach enhances the accuracy and effectiveness of fraud detection or other ML tasks by ensuring that the models are optimized to identify certain activities, such as fraudulent activities, within their respective clusters.

By combining ML clustering with customized ML model development, the service provider may create a more comprehensive and effective fraud detection system. This approach enables the service provider to better spot and analyze unique fraud patterns that may be present within each group, leading to more accurate detection and prevention of fraudulent activities. Traditional fraud detection methods often generate a high number of false positives, resulting in detection inefficiencies, unnecessary investigation, and customer inconvenience. The customized ML models disclosed herein aim to minimize false positives by focusing on detecting genuine fraud patterns within each cluster, thereby improving operational efficiency and customer satisfaction. By improving the accuracy and efficiency of fraud detection processes, these ML models can lead to significant fraud detection improvements including improved accuracy, reduced cost and loss, and better operational efficiency. As such, these ML models may reduce losses due to fraud, lower operational costs associated with investigating false positives, and increase customer trust and loyalty.

The embodiments described herein provide methods, computer program products, and computer database systems for an ML system that programmatically processes training data to cluster into distinct and separate data sets that exhibit, have, or include the same or similar traits, characteristics, patterns, behaviors, and the like. Thereafter, these clustered data sets each may be used to train an ML model for fraud detection or other ML task, thereby providing more accurate and comprehensive model training and inferencing on separate and customized data sets for specific data populations and representations. A financial institution, or other service provider having one or more financial institutions as customers or other tenants, may therefore include and/or utilize a fraud and/or money laundering reporting system that may implement the ML system as described herein. The framework of intelligent fraud detection, or another ML task, may be improved through the ML clustering and training operations provided herein.

According to some embodiments, in an ML system accessible by a plurality of separate and distinct organizations, ML algorithms, features, and models are provided for intelligently clustering training data and training customized ML models, thereby providing more accurate, efficient, and precise ML model training with comprehensive understanding of nuanced data and patterns in the training data.

### Example System and Computing Environment

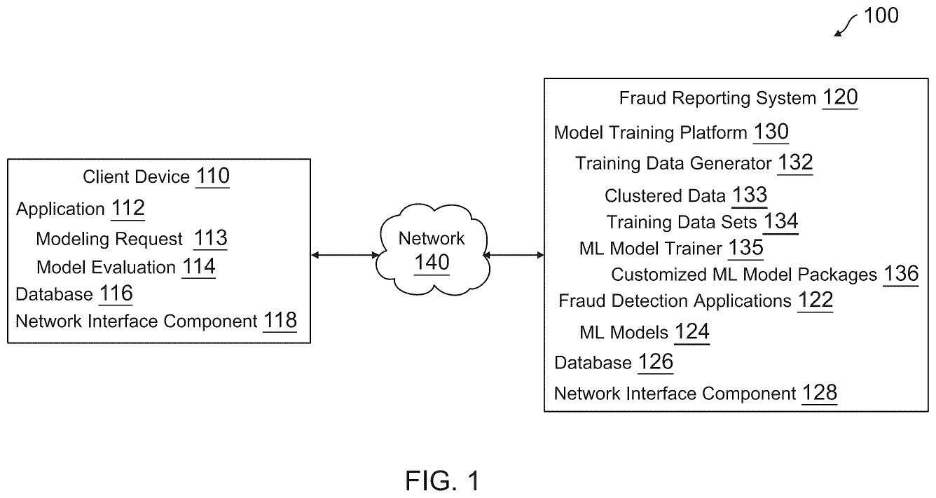

The system(s) and methods of the present disclosure can include, incorporate, or operate in conjunction with, or in the environment of, an ML engine, model, and intelligent system, which may include an ML or other AI computing architecture that provides ML model training using clustered data sets from training data. FIG. 1 is a block diagram of a networked environment 100 suitable for implementing the processes described herein according to an embodiment. As shown, environment 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed, and/or the services provided, by such devices and/or servers may be combined or separated for a given embodiment and may be performed by a greater number or fewer number of devices and/or servers. For example, ML models, neural networks (NNs), and other AI architectures have been developed to improve predictive analysis and classifications by systems in a manner similar to human decision-making, which increases efficiency and speed in performing predictive analysis on datasets requiring machine predictions, classifications, and/or analysis. One or more devices and/or servers may be operated and/or maintained by the same or different entities.

FIG. 1 illustrates a block diagram of an example environment 100 according to some embodiments. Environment 100 may include a client device 110 and a fraud reporting system 120 that interact over a network 140 to provide intelligent fraud/AML detection and/or investigation, or other ML task processing, through ML clustering models that may cluster training data (e.g., data records of fraudulent transactions or actors with valid transactions or actors) and train ML models for specific and customized ML tasks from the clustered training data, as discussed herein. In other embodiments, environment 100 may not have all of the components listed and/or may have other elements instead of, or in addition to, those listed above. In some embodiments, environment 100 is an environment in which a model training platform 130 may cluster training data and train ML models. As illustrated in FIG. 1, fraud reporting system 120 might interact via a network 140 with client device 110 to train, configure, and provide evaluations of ML models.

For example, in fraud reporting system 120, fraud detection applications 122 may provide and/or process transaction data, user data, and/or historical data for fraud/AML analysis using one or more ML or NN models, which may include LLMs, generative pretrained transformers (GPTs), and other generative and/or conversational AI. ML models 124 may be trained from clusters of data that are generated by ML clustering models; however, other types of ML tasks and/or ML models may be used. The ML clustering models may cluster training data according to characteristics, ML features, data attributes or variables, and the like. Fraud flags and/or reports may be generated from detected or suspected fraud, which may be detected by ML models 124 trained using ML modeling and training techniques and algorithms.

ML models 124 for detecting fraud by fraud detection applications 122 may correspond to different types of ML models including clustering models, decision trees, NNs, and the like. In this regard, ML models 124 may be trained by model training platform 130 using training data generated by a training data generator 132. ML models 124 may include offline and/or online ML models, where offline ML models may be trained and deployed based on a training data set and online ML models may provide continuous learning and adaptation to new and changing datasets, such as emerging trends using live or streaming data. As such, fraud reporting system 120 may be utilized to provide ML operations to tenants, customers, and other users or entities via fraud detection applications 122, which may include detecting and processing fraud data and potentially fraudulent activities using ML models 124 trained by model training platform 130. ML models 124 may be trained by an ML model trainer 135 based on clustered data 133 determined, clustered, and/or generated by training data generator 132. Based on clustered data 133, training data generator 132 may generate and provide training data sets 134 with corresponding ML features, metadata, and the like for more specific, nuanced, and specialized models, which may be trained from certain patterns, behaviors, traits, characteristics, or other cluster parameters.

To investigate real or potential fraud, ML models 124 may be trained by ML model trainer 135 using training data sets 134, which may output customized ML model packages 136 that are deployed with fraud detection applications 122 as ML models 124. Fraud detection applications 122 may therefore provide fraud/AML services through ML models 124 after training. Training data generator 132 may utilize a clustering technique or algorithm, including k-means clustering, to cluster an initial training data set, such as data records of valid and/or fraudulent transactions or actors. ML models 124 may include and/or be utilized in conjunction with computing services provided by and/or to customers, tenants, and other users or entities accessing and utilizing fraud reporting system 120 through fraud detection applications 122. ML fraud/AML engines of fraud detection applications 122 may be executed by fraud reporting system 120 and/or provided to be utilized with other ML systems and models, such as those managed by separate computing systems, servers, and/or devices (e.g., tenant-specific or tenant-controlled servers and/or server systems that may be separate from model training platform 130 discussed herein). Client device 110 may include an application 112 that provides a modeling request 113 that requests training data be clustered and utilized for training of ML models 124. As such, modeling request 113 may initiate a process to generate customized ML model packages 136 and deploy such packages in a production computing environment as ML models 124. ML models 124 may be analyzed and evaluated for model performance in test and/or production environments after deployment from customized ML model packages 136, and a model evaluation 114 may be provided to client device 110 so that performance may be determined, and retraining, deployment, or other actions taken.

In this regard, model training platform 130 may receive modeling request 113, which may include training data and/or a designation of training data to access or retrieve. Model training platform 130 may determine a set of training data having different data records, or other data that may be clustered, such as transaction records, user profiles or histories, and the like. The training data may therefore include discreet data portions, values, records, or points that may be clustered according to their parameters, such as attributes or variables from the data, which may correspond to ML model features for training. Training data generator 132 may be invoked and/or executed to cluster the training data according to their features and cluster parameters or settings, such as an initial number of cluster (e.g., k clusters for k-means clustering). An ML clustering algorithm and/or technique may be applied to determine a number of clusters, cluster membership or representation, cluster centroids, cluster size and/or distance from a cluster centroid, and the like. The resulting clusters may correspond to clustered data 133, which may then be packaged and/or correlated with their corresponding clustered information, metadata, parameters, and the like for training data generation. For example, each cluster of clustered data 133 may correspond to a separate data set of data records, such as transactions or users, and may have information regarding how or why those data records in the set belong to that cluster, such as cluster metadata indicating the attributes, variables, or features of importance, correlation, or similarity between the data records.

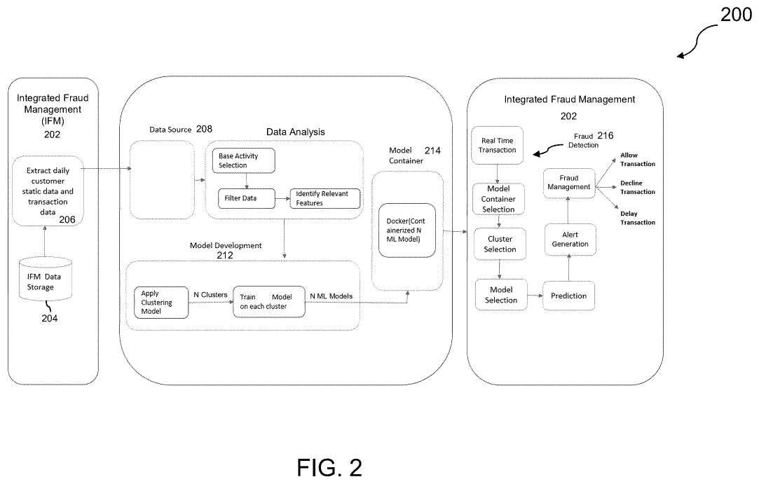

As such, training data sets 134 may be created from clustered data 133 based on the corresponding information and/or metadata, and therefore may correspond to individual and separate data sets from the initial training data input. This may allow for training of more specific and customized ML models for the specific data patterns, behaviors, and the like of each clustered data set from the training data. ML model trainer 135 may then access and/or receive training data sets 134 and train customized ML models for each data set, which may be packaged for output and deployment as customized ML model packages 136. Customized ML model packages 136 may therefore allow for modular deployment of ML models 124. As such, model training platform 130 may not rigidly specify a certain ML or AI model for specific inferencing and/or detecting purposes, and ML models may be added or removed modularly and as needed. Although model training and inferencing services are discussed as internal and residing with fraud reporting system 120, in other embodiments, external or third-party AI services and platforms may be similarly called. The operations, components, and models of model training platform 130, such as those of training data generator 132 and ML model trainer 135, are discussed in further detail below with regard to FIGS. 2-6 below.

For ML models (e.g., clustering algorithms and operations, decision trees and corresponding branches, NNs, etc.), the models may be trained using training data, which may correspond to stored, preprocessed, and/or feature transformed data used to cluster, determine, and generate clustered data 133. With continuous and/or reinforcement training, live streaming data from one or more production, live, and/or real-time computing environments may be used. Model training and configuring may include performing feature engineering and/or selection of features used by ML models. Features may correspond to discreet, measurable, and/or identifiable properties or characteristics; however, as discussed herein, ML and NN models used by fraud reporting system 120 may be trained using one or more ML algorithms, operations, or the like for modeling (e.g., including clustering data points and/or embeddings, configuring decision trees or neural networks, and/or adjusting clusters, weights, activation functions, input/hidden/output layers, and the like). Thus, one or more ML models, NNs, or other AI-based models and/or engines may be trained for fraud/AML detection, investigation, or another ancillary ML task. The training data may be labeled or unlabeled for different supervised or unsupervised ML and NN training algorithms, techniques, and/or systems. Fraud reporting system 120 may further use features from such data for training, where the system may perform feature engineering and/or selection of features used for training and decision-making by one or more ML, NN, or other AI algorithms, operations, or the like (e.g., including configuring clusters, cluster representatives and/or membership/attribution, decision trees, weights, activation functions, input/hidden/output layers, and the like). ML model 124 and/or other ML models be trained using a function and/or algorithm used by ML model trainer 135, as well as other ML systems, trainers, and operations for model and/or engine training and development. The training may include establishment and/or adjustment of clusters, cluster similarity distances, weights, activation functions, node values, and the like. After initial training of ML models using supervised or unsupervised ML algorithms (or combinations thereof), ML models may be evaluated and/or released in a production computing environment. ML models may be deployed to take and process input data for model features and predict labels or other classifiers from the input data.

One or more client devices and/or servers (e.g., client device 110 using application 112) may execute a web-based client that accesses a web-based application for fraud reporting system 120, or may use a rich client, such as a dedicated resident application, to access fraud reporting system 120, which may be provided by fraud detection applications 122 to such client devices and/or servers. Client device 110 and/or other devices or servers may utilize one or more application programming interfaces (APIs) to access and interface with fraud detection applications 122 and/or ML fraud/AML engines of fraud reporting system 120 to access, review, and evaluate transactions, fraud indications, and/or other ML tasks using the operations discussed herein. Interfacing with fraud reporting system 120 may be provided through fraud detection applications 122 and/or model training platform 130, and may be based on data stored by databases 126 of fraud reporting system 120 and/or a database 116 of client device 110.

Client device 110 and/or other devices and servers on network 140 might communicate with fraud reporting system 120 using TCP/IP and, at a higher network level, use other common Internet protocols to communicate, such as hypertext transfer protocol (HTTP or HTTPS for secure versions of HTTP), file transfer protocol (FTP), wireless application protocol (WAP), etc. Communication between client device 110 and fraud reporting system 120 may occur over network 140 using a network interface component 118 of client device 110 and a network interface component 128 of fraud reporting system 120. In an example where HTTP/HTTPS is used, client device 110 might include an HTTP/HTTPS client for application 112, commonly referred to as a “browser,” for sending and receiving HTTP//HTTPS messages to and from an HTTP//HTTPS server, such as fraud reporting system 120 via the network interface component.

Similarly, fraud reporting system 120 may host an online platform accessible over network 140 that communicates information to and receives information from client device 110. Such an HTTP/HTTPS server might be implemented as the sole network interface between client device 110 and fraud reporting system 120, but other techniques might be used as well or instead. In some implementations, the interface between client device 110 and fraud reporting system 120 includes load sharing functionality. As discussed above, embodiments are suitable for use with the Internet, which refers to a specific global internet of networks. However, it should be understood that other networks can be used instead of or in addition to the Internet, such as an intranet, an extranet, a virtual private network (VPN), a non-TCP/IP based network, any LAN or WAN, or the like.

Client device 110 and other components in environment 100 may utilize network 140 to communicate with fraud reporting system 120 and/or other devices and servers, and vice versa, which network 140 is any network or combination of networks of devices that communicate with one another. For example, network 140 can be any one or any combination of a local area network (LAN), wide area network (WAN), telephone network, wireless network, point-to-point network, star network, token ring network, hub network, or other appropriate configuration. As the most common type of computer network in current use is a transfer control protocol and Internet protocol (TCP/IP) network, such as the global inter network of networks often referred to as the Internet. However, it should be understood that the networks that the present embodiments might use are not so limited, although TCP/IP is a frequently implemented protocol. Further, one or more of client device 110 and/or fraud reporting system 120 may be included by the same system, server, and/or device and therefore communicate directly or over an internal network.

According to one embodiment, fraud reporting system 120 is configured to provide webpages, forms, applications, data, and media content to one or more client devices and/or to receive data from client device 110 and/or other devices, servers, and online resources. In some embodiments, fraud reporting system 120 may be provided or implemented in a cloud environment, which may be accessible through one or more APIs with or without a corresponding graphical user interface (GUI) output. Fraud reporting system 120 further provides security mechanisms to keep data secure. Additionally, the term “server” is meant to include a computer system, including processing hardware and process space(s), and an associated storage system and database application (e.g., object-oriented data base management system (OODBMS) or relational database management system (RDBMS)). It should also be understood that “server system” and “server” are often used interchangeably herein. Similarly, the database objects described herein can be implemented as single databases, a distributed database, a collection of distributed databases, a database with redundant online or offline backups or other redundancies, etc., and might include a distributed database or storage network and associated processing intelligence.

In some embodiments, client device 110, shown in FIG. 1, executes processing logic with processing components to provide data used for fraud detection applications 122 and/or model training platform 130 of fraud reporting system 120. In one embodiment, client device 110 includes application servers configured to implement and execute software applications as well as provide related data, code, forms, webpages, platform components or restrictions, and other information, and to store to, and retrieve from, a database system related data, objects, and web page content. For example, fraud reporting system 120 may implement various functions of processing logic and processing components, and the processing space for executing system processes, such as running applications for fraud/AML investigations and/or other risk analysis and fraud/AML capabilities. Client device 110 and fraud reporting system 120 may be accessible over network 140. Thus, fraud reporting system 120 may send and receive data to client device 110 via network interface component 128. Client device 110 may be provided by or through one or more cloud processing platforms, such as Amazon Web Services® (AWS) Cloud Computing Services, Google Cloud Platform®, Microsoft Azure® Cloud Platform, and the like, or may correspond to computing infrastructure of an entity, such as a financial institution.

Several elements in the system shown and described in FIG. 1 are explained briefly here. For example, client device 110 could include a desktop personal computer, workstation, laptop, notepad computer, PDA, cell phone, or any wireless access protocol (WAP) enabled device or any other computing device capable of interfacing directly or indirectly to the Internet or other network connection. Client device 110 may also be a server or other online processing entity that provides functionalities and processing to other client devices or programs, such as online processing entities that provide services to a plurality of disparate clients. Client device 110 may run an HTTP/HTTPS client, e.g., a browsing program, such as Microsoft's Internet Explorer or Edge browser, Mozilla's Firefox browser, Opera's browser, or a WAP-enabled browser in the case of a cell phone, tablet, notepad computer, PDA or other wireless device, or the like. According to one embodiment, client device 110 and all of its components are configurable using applications, such as a browser, including computer code run using a central processing unit such as an Intel Pentium® processor or the like. However, client device 110 may instead correspond to a server configured to communicate with one or more client programs or devices, similar to a server corresponding to fraud reporting system 120 that provides one or more APIs for interaction with client device 110.

Thus, client device 110 and/or fraud reporting system 120 and all of their components might be operator configurable using application(s) including computer code to run using a central processing unit, which may include an Intel Pentium® processor or the like, and/or multiple processor units. A server for client device 110 and/or fraud reporting system 120 may correspond to Window®, Linux®, and the like operating system server that provides resources accessible from the server and may communicate with one or more separate user or client devices over a network. Exemplary types of servers may provide resources and handling for business applications and the like. In some embodiments, the server may also correspond to a cloud computing architecture where resources are spread over a large group of real and/or virtual systems. A computer program product embodiment includes a machine-readable storage medium (media) having instructions stored thereon/in which can be used to program a computer to perform any of the processes of the embodiments described herein utilizing one or more computing devices or servers.

Computer code for operating and configuring client device 110 and fraud reporting system 120 to intercommunicate and to process webpages, applications and other data and media content as described herein are preferably downloaded and stored on a hard disk, but the entire program code, or portions thereof, may also be stored in any other volatile or non-volatile memory medium or device, such as a read only memory (ROM) or random-access memory (RAM), or provided on any media capable of storing program code, such as any type of rotating media including floppy disks, optical discs, digital versatile disk (DVD), compact disk (CD), microdrive, and magneto-optical disks, as well as other media including magnetic or optical cards, nanosystems (including molecular memory integrated circuits (ICs)), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, virtual private network (VPN), LAN, etc.) using any communication medium and protocols (e.g., TCP/IP, HTTP, HTTPS, Ethernet, etc.) as are well known. It will also be appreciated that computer code for implementing embodiments of the present disclosure can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun MicroSystems, Inc.).

### Training Data Clustering and Model Training System

FIG. 2 is a simplified system architecture 200 of a service provider that may utilize customized ML models trained from separate training data sets of clustered data according to some embodiments. System environment 200 of FIG. 2 includes an integrated fraud management module (IFM) 202 that may interact with a fraud detection system 203 to perform ML clustering of training data, which may then be used for customized and tailored ML model training. In this regard, the operations to process data from an IFM data storage 204 and train ML models described with reference to and shown in system architecture 200 may be executed by the operations and components of fraud reporting system 120 including model training platform 130 discussed in reference to environment 100 of FIG. 1.

A service provider, such as a fraud or money laundering detection system and/or server(s) (e.g., fraud reporting system 120), may implement and deploy a fraud detection and management system shown in system architecture 200 through IFM 202 and fraud detection system 203. In IFM 202, an IFM data storage 204 may correspond to a database or other data store, including cloud storage components, where customer static and transaction data may be stored and reside. A base activity for which one or more models are to be created may be identified, such as fraud detection for a specific task, subset of transactions or users, common pattern, or another ML task. As such, clusters may be created to provide customized ML models for the particular data sets resulting from the clusters, such as certain transactions and/or populations of users. IFM data storage 204 may include customer static data, such as a name, address, contact details, account history, product subscriptions, preferred banking channels and/or transaction services, and the like. IFM data storage 204 may further store transaction data including a transaction type, amount, timestamp, location, merchant details, device information, and the like. An extraction process 206 may extract daily customer static and transaction data, which may be gathered and determined from the raw stored data and used for ML model building and training. As such, extraction process 206 may provide the extracted data from IFM data storage 204 to data source 208, which may store and hold the data from further processing by a data analysis 210.

As such, data analysis 210 may access data source 208 to retrieve and/or determine the data for ML clustering and model training. Data analysis 210 may retrieve the data from data source 208 via a query service and from one or more object storage services and/or central repositories of data. During data analysis 210, the base activity is identified for which ML models are to be trained, which allows for mapping of transactions or other data to the base activity. Data may be filtered during pre-processing and relevant features may be identified. For example, during data filtering, certain transactions or other data records may be fetched that are relevant to the base activity, which may be filtered and/or restricted to a particular time period. For relevant features of transactions, data analysis 210 may identify customer-based features (e.g., average transaction amount, typical spending categories, preferred locations and channels, etc.), transaction-based features (e.g., transaction type, amount, location, time, currency used (for international transactions), etc.), and/or device-based features (e.g., IP address, device type, operating system, location data, etc.). Typically, the filtering associated with the disclosure is on a real-time or near-real time basis, or on an hours/overnight type basis to be most useful for fraud detection and investigation, and the quantity of data filtered is not performable by a human on any reasonable time-scale less than years or possibly months.

Fraud detection system 203 may then perform a model development 212 on the data from data analysis 210. Initially, a clustering model is applied to cluster the training data having transactions or other data records. To effectively combat the increasing sophistication of fraudsters and address the limitations of a single ML model for diverse fraud patterns, behaviors, trends, and the like, clustering of the data initially may provide a multi-layered fraud detection strategy that leverages ML clustering for tailored machine learning models. As such, unsupervised clustering algorithms may be applied to both static and non-static training data to create distinct clusters (e.g., cluster 1 to cluster N) representing groups with potentially different fraud patterns. Model development 212 may thereafter train ML models on each cluster, such as using XGBoost or other training algorithm and/or technique. As such, model development 2212 may develop a unique machine learning model specifically trained for each cluster (e.g., model 1 to model N). This approach allows for more accurate predictions within each group's unique fraud characteristics.

Once ML models have been trained on the separate data sets clustered from the initial training data, model containers 214 may be used to package each ML model for deployment. Containerization of the ML models for generation of model containers 214 may correspond to a process by which the ML models are each packaged into a data container or the like, which allows for portability and modular use. This may utilize DOCKER™ or other containerization technology and operations, where model containers 214 may include N containerized ML models. Orchestration tools may be used to deploy the containerized models in production, and IFM may then perform a fraud detection 216 on one or more incoming new transactions using the ML model packages and customized ML models. As such, a real-time transaction may be analyzed by selecting one or more model containers, performing a clustering of the real-time transaction to identify a corresponding established cluster, selecting a fraud detection model that corresponds to the cluster from the selected model container(s), and making a prediction or assessing/predicting fraud based on the transaction and ML model. Thereafter alert generation may occur if the transaction indicates fraud, where a fraud management process may allow the transaction, decline, or delay to minimize fraud.

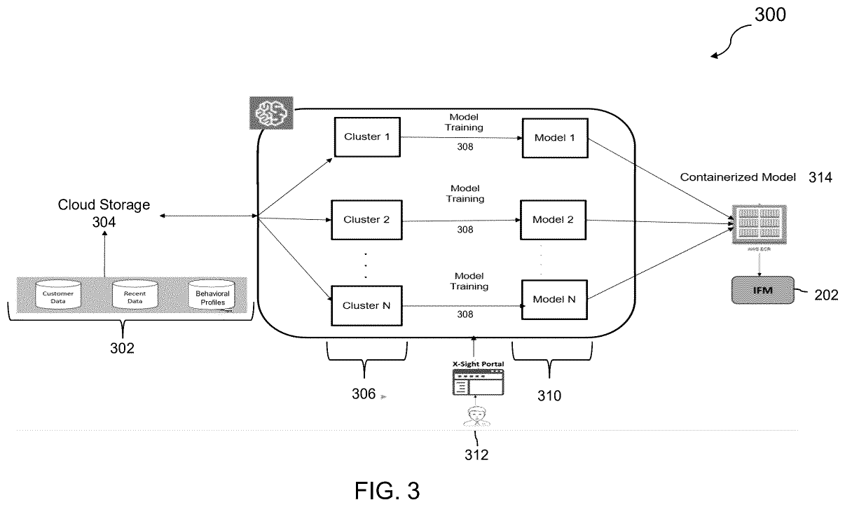

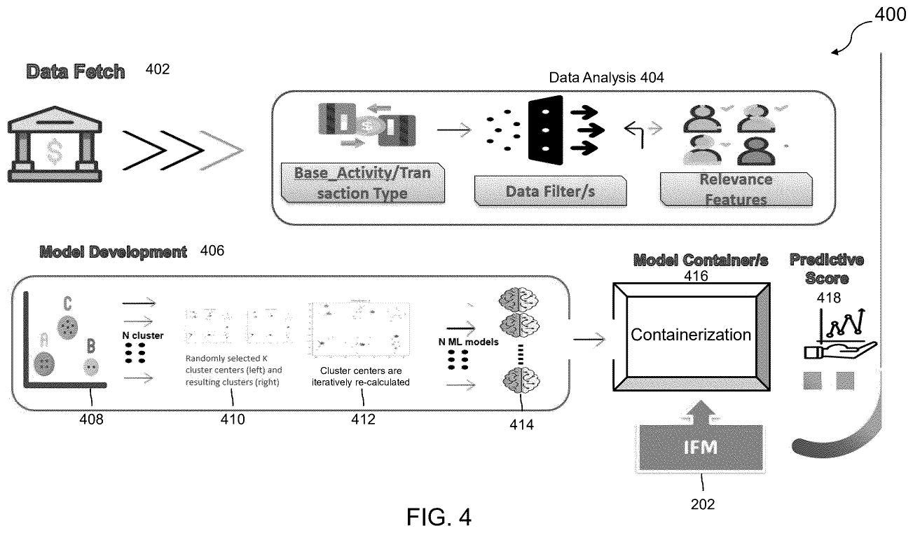

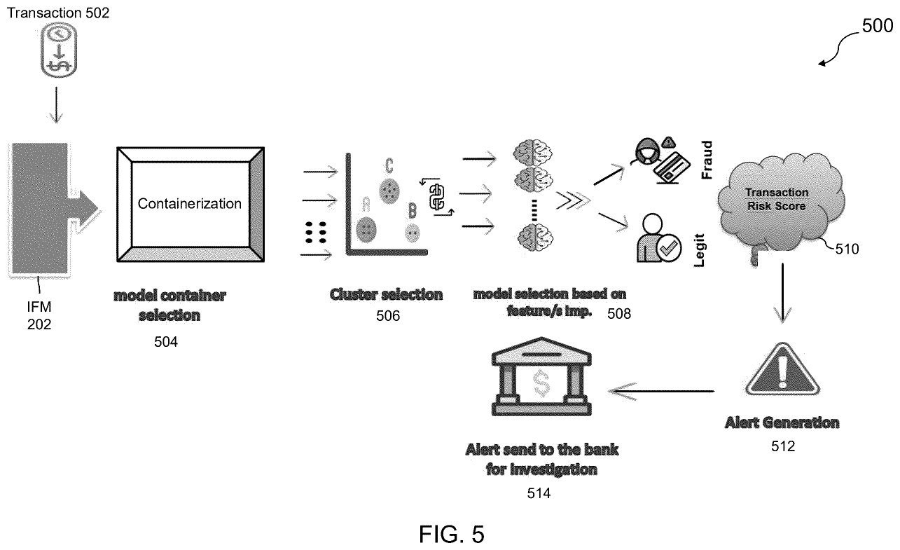

FIG. 3 is a simplified diagram 300 for generating separate training data sets and training customized ML models for specific ML tasks and data patterns according to some embodiments. FIG. 3 is discussed with reference to FIGS. 4 and 5. In this regard, FIG. 4 is a simplified diagram 400 of customized ML model development based on clustered data, and FIG. 5 is a simplified diagram 500 of ML model selection for ML inferencing using customized ML models for specific ML tasks and data patterns, according to some embodiments. Diagrams 300-500 represent training and use of ML models from separate data sets generated through ML clustering of training data for a particular base activity of interest, such as a particular transaction type, pattern, behavior, participant, or the like. As such, diagrams 300-500 may be performed by fraud reporting system 120 including fraud detection applications 122 and/or model training platform 130 discussed in reference to environment 100 of FIG. 1.

Initially, a service provider, such as a fraud detection system and/or provider, may perform data collection of data records 302 from a cloud storage 304, such as an Amazon S3 storage or other similar cloud storage component. The data essential for analysis originates from this object storage service in cloud storage 304, which may correspond to a secure and scalable object storage service within a cloud computing environment or networked server architecture. The service provider may collect different customer information encompassing a diverse range of data types. The information may include static customer data, such as demographic details and contact information, historical behavioral profiles, which capture past interactions and preferences, and recent transaction data, which provide insights into current patterns. As such, in diagram 400, a data fetch 402 is performed to accrue, gather, extract, and/or retrieve this data for a data analysis 404, such as transaction information from transactions processed by a bank or other financial institution. Data analysis 404 is then performed on the data from cloud storage 304 fetched and retrieved by data fetch 402. Data analysis 404 may include identifying a base activity, performing data filtration, and identifying relevant features.

The service provider may then utilize unsupervised clustering algorithms to group parties into distinct clusters 306 based on shared attributes and behaviors. Distinct clusters 306 may each represent different segments of the population with potentially unique fraud patterns. When clustering distinct clusters 306 from the training data, the service provider may first select the number of clusters for dataset 408, such as “K” clusters shown by their individual cluster groupings and representatives. For example, in diagram 400, cluster centers 410 may be randomly selected and clusters may initially be determined from these random centers. Selecting the random centers may include selecting a K number of centroids randomly from the dataset and using Euclidean distance or Manhattan distance as a metric to calculate the distance of the other data points from the nearest centroid, which may then be used to assign the data points to the nearest cluster centroid, thereby creating K clusters. Thereafter, the service provider finds the new centroid of the clusters formed and reassigns data points based on the new centroid and repeats for a number of iterations during an iterative recalculation 412. The service provider may continue this for a given number of iterations until the position of the centroid doesn't change, i.e., there is no more convergence. For the optimal number of clusters, such as the optimum K value, the number may be determined using the Elbow Method. Hence, the service provider may apply unsupervised clustering algorithms to both static and non-static party data, which creates distinct clusters representing groups with potentially different fraud patterns.

In some embodiments, prior to clustering, additional steps may be performed including data filtration, exploratory data analysis, data enrichment, feature selection, data preparation for model training, and the like. For example, during a pre-processing step, not all extracted data may be determined to be equally relevant for fraud detection. As such, this stage may filter out irrelevant or redundant information, focusing on the key features that best distinguish fraudulent activities. For example, if the service provider is creating models for retail customers, then using commercial data may add noise to the model. As a result, the service provider may apply a filter to only fetch relevant data that can be used for model training. As another example for model training, the service provider may take the last 6 months of data and therefore may apply a filter to only fetch the last 6 months of data. When identifying relevant features, the service provider may execute a process of identifying the features from the filtered data that may be used to train the ML model. Data scientists and fraud analysts may be used to identify these features, or the features may be determined and/or inferred from previous models and/or model configurations. The features may include customer-based features, including an average transaction amount, typical spending categories, preferred locations and channels; transaction-based features including transaction type, amount, location, time, currency used (for international transactions); and/or device-based features including IP address, device type, operating system, location data.

Thereafter, the service provider may proceed to a model training 308 in diagram 300. After using a clustering model to cluster the data and data records in the data into groups based on their characteristics and the corresponding ML features, the service provider may proceed with model training 308 to create N ML models 414 in diagram 400. Model training 308 of N ML models 414 may include training an XGBoost model for each unique clustered data set from the initial training data and data records (e.g. after clustering). XGBoost may be chosen for fraud detection due to its efficiency when handling complex data structures; however, other types of ML models including NNs may also be trained using different ML algorithms and training techniques. The filtered data with identified features may be provided to an XGBoost algorithm trainer, allowing the model to learn and identify fraudulent patterns. As such, model training 308 may result in models 1-N 310, which may be used for fraud detection for patterns or other data characteristics representative of distinct clusters 306.

After model training 308, model evaluation and selection may be performed according to testing parameters, metrics, and benchmarks. Model evaluation may include computing model lift, detection rate, value detection rate, and/or other evaluation metrics. Thus, model metrics may be used to test and evaluate the models for adequate performance, such as performance that meets or exceeds a threshold or benchmark. Once sufficiently tested and considered for deployment, model packaging may be performed by containerizing each of the models, such as by creating containerized models 314 and model containers 416. For example, in diagram 400, containerization of models 1-N 310 for real-time fraud detection may include packaging or containerizing each ML model into individual data containers or packages, shown as model containers 416, for deployment and execution by a fraud detection engine or other ML data processing platform. Similarly, containerized models 314 may be packaged using DOCKER™ or other containerization mechanism allows packaging the chosen ML model along with all its dependencies (libraries, frameworks, etc.) into a lightweight, portable unit called a container.

Since clustering is used to generate sub-data sets from an overall data set based on clustered characteristics associated with ML features, during containerization of containerized models 314 and model containers 416, a clustering model object along with its dependencies may also be containerized so that ML model selection during inferencing may be performed. This ensures both the clustering logic and the specific ML models for each cluster are packaged and deployed together. As such, with the chosen ML model(s), whether a single selected model or multiple models for different scenarios, each are containerized. This creates portable and isolated units for containerized models 314 and model containers 416, simplifying deployment and management.

As shown in diagram 400, containerization allows IFM 202 to deploy the models for predictive scores 418. Once the models are containerized, they may be deployed in a production environment with model orchestration tools for model execution. For example, in diagrams 300 and 400, IFM may access and deploy containerized models 314 and model containers 416. Following deployment, transactions or other activities, events, and/or data records may be analyzed in a live and/or real-time production computing environment. This may include using container orchestration tools, such as Kubernetes, to manage the lifecycle of the containers, ensuring the containers run smoothly and are scaled appropriately to handle real-time traffic. For example, in diagram 500, a transaction 502 is received by IFM 202, which may perform a model container selection 504. Model container selection 504 may include selecting one or more model containers that may correspond to transaction 502 and/or the corresponding base activity.

After model container selection 504, transaction 502 may be grouped and clustered based on shared characteristics, and thereafter compared to the established clusters during a cluster selection 506. This allows for assignment of transaction 502 to a particular cluster. By identifying the particular cluster, the service provider may then select the corresponding ML model during a feature importance-based model selection 508. In this regard, during feature importance-based model selection 508, using the transaction's cluster and corresponding unique patterns and/or characteristics, an ML model for inferencing may be selected and utilized for fraud prediction or another ML related task. This allows for more targeted and accurate predictions for transaction 502. As such, a transaction risk score 510 may be computed and/or determined by the corresponding ML model. Transaction risk score 510 may be used for an alert generation 512 if potential fraud exists or is predicted/detected, and a bank alert 514 may be issued.

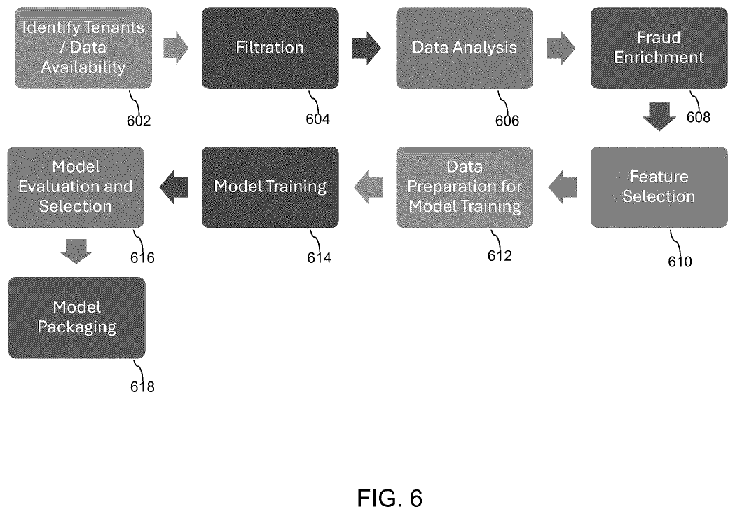

FIG. 6 is a simplified diagram of an exemplary flowchart 600 for generating separate training data sets from ML clustering and training customized ML models using the data sets according to some embodiments. Note that one or more steps, processes, and methods described herein of flowchart 600 may be omitted, performed in a different sequence, or combined as desired or appropriate based on the guidance provided herein. Flowchart 600 of FIG. 6 includes operations executable by an ML modeling system that clusters training data into unique and separate data sets prior to model training, where ML models are then trained for specific and customized tasks depending on the clusters, as discussed in reference to FIG. 1-5. One or more of steps 602-618 of flowchart 600 may be implemented, at least in part, in the form of executable code stored on non-transitory, tangible, machine-readable media that when run by one or more processors may cause the one or more processors to perform one or more of steps 602-618. In some embodiments, flowchart 600 can be performed by one or more computing devices discussed in environment 100 of FIG. 1.

At step 602 of flowchart 600, tenants and data availability are identified. Tenants may be identified by a base activity of interest for ML model inferencing and/or predicting, and data is extracted from a database. The database may correspond to one used by an IFM for fraud detection and management over a selected time period. The data extraction may be performed based on the same or similar base activity or other grouping of events within client systems that serve as a logical framework for profiling and detection purposes. For example, a base activity associated with transactions may correspond to “Commercial International Wire Transfer via Offline Channel.” The data for analysis may then be sourced and retrieved from one or more databases, such as cloud storages, to extract relevant information based on specific criteria. To enhance the model sophistication, more recently used data may be prioritized and/or augmented with specific attributes for a comprehensive data set.

At step 604, data filtration is performed. During step 604, data cleaning procedures may be performed in order to eliminate unreliable and/or inconsistent data. Further, certain data input values and/or categorical observations may be required to be transformed into processable numerical values, which may facilitate their incorporation into a final model equation and algorithmic training. Transactions that have undergone filtering processes and are deemed unnecessary for model development may be excluded from consideration. Filters, in this context, may represent technical or business rules applied to evaluate incoming transactions. The filters, or rules, may therefore streamline transaction or other data record processing by determining whether a transaction or other data record requires further assessment by an ML model, e.g., whether it is relevant to the accuracy of an ML model, such as a current fraud detection or a pattern evaluation. As such, step 604 may include gathering data from various sources, extracting relevant information based on predefined criteria (e.g., a comprehensive set of features for model development), and applying filtering rules to streamline transaction processing before model evaluation. Further, as in step 602, the recency of data may be relevant and the data may be augmented to provide prioritization to more recent data during training. Lastly, quality control and data validation checks may be performed on the data set to identify any anomalies or issues that could compromise the quality of the model.

At step 606, exploratory data analysis (EDA) and/or data enrichment is performed. During EDA, data cleaning may include identifying and handling (e.g., by removing or substituting with a preset value) null values, missing values, and features with zero variance (i.e., the values are constant across all data sets). Feature engineering may be performed to enhance existing data by creating new features for the ML model to be trained. The new features may be derived from the input variables and provide additional information that aid the model in inferencing and providing accurate predictions or outputs. New features may be created by transforming existing data variables into specific features, such as dates to “month,” “day,” and “hour.” The feature transformation may be performed based on business logic and categorical features may be encoded into frequency-based features or the like using one-hot encoding, lift-based encoding, and/or population-based encoding.

At step 608, fraud enrichment is performed. Fraud enrichment may augment data with additional fraud labels based on existing information related to known fraudulent transactions. This may include rectifying mislabeled transactions, which may be performed by analyzing the transactions known to be fraudulent with those transactions that are closely associated with the known fraudulent transactions. Business rules and/or fraud enrichment assumptions may be made to correlate those transactions marked as legitimate transactions with fraudulent transactions, and therefore also mark or enrich the transactions with fraud labels. For example, legitimate transactions occurring the day before or after the fraudulent transaction, those having the same payee or key party, and the like may also be marked as fraudulent. As such, additional fraud labels may be added to the training data.

At step 610, feature selection is performed. During feature selection, all available features are considered for inclusion. For transactions, the selected features may include transaction-related information including details about the transaction and the party initiating the transaction. Additionally, session information describing the device used for the transaction and the device's connection pathway, along with the sequence of transactions within the session, may also be included. Data preprocessing and cleaning may be run on the training data to remove duplicate columns, high cardinal columns, and/or zero variance columns. As such, irrelevant features may be removed, and only those relevant features may be retained.

At step 612, data preparation for model training is performed. Data preparation may include splitting the data into train and test data sets and performing data sampling based on a sampling strategy. A train and test data set may allow for the model to be trained on one subset of the training data, while tested on the other subset, which allows for an unbiased assessment of model performance. During sampling, all fraudulent transaction may be retained while a subset of the legitimate transactions, or other observations, are sampled and/or selected, such as through randomization or procedural selection based on a set of criteria or rules. The training data may be split according to 80% training and 20% testing, but other ratios and/or percentages may also be used. Further it may be important to ensure that the training data precedes the testing data, to avoid any potential data leakage where temporal order is important.

At step 614, model training is performed. A multi-layered fraud detection strategy may be performed that leverages clustering to tailor specific and customized ML models to subsets of the training data. The subsets may be represented by clustered data records, which may be clustered using an ML clustering model and/or algorithm, such as k-means clustering. For the optimal number of clusters, such as the optimum k value, the number may be determined using the Elbow Method or other technique that may determine a number of centroids to utilize during clustering. For example, the Elbow Method may provide a graphical process by which a sum of the square distance between points in a cluster and cluster centroid may be graphed and a point selected along the “elbow” point or inflection in a line graph of those points. This may be performed by finding the “within-cluster sum of square” (WCSS) values and mapping/graphing those values on an x-y axis, where the value on the y-axis where the elbow occurs may correspond to the optimal centroids on the x-axis.

For each cluster identified, a specifically tailored ML model may be trained to detect fraud or perform another observation, prediction, or inference based on the fraud or other patterns in or associated with that cluster. The relevant features for the data set that indicate fraudulent activity may be selected, which may be used to train an ML model on historical data associated with the cluster. Thereafter, ML model training may be performed using an ML modeling technique and/or algorithm, such as XGBoost. For example, XGBoost may be used to train tree-based ML models from the clustered data sets of the training data, thereby creating multiple customized ML models for the specific data sets and their clustered behaviors, traits, or patterns. Training may include fitting the ML model to the data and/or optimizing the parameters of the model to maximize performance. To perform model training, the model may be initialized to create a base prediction, a first tree may be fitted using the features and residuals (e.g., in a greedy manner where informative features are selected first), loss may be computed, and a next tree may be fitted. These steps may be repeated for a number of iterations, and predictions may then be made using the ensemble of decision trees.

At step 616, model evaluation and selection are performed. Model evaluation may be performed by computing different evaluation metrics, such as lift, detection rate, and/or value detection rate. Lift may correspond to an improvement or enhancement achieved by the new approach compared to the traditional one. Lift may therefore be determined using detection rate and/or value detection rate, where detection rate refers to the proportion of relevant items correctly identified and value detection rate refers to the model's availability to identify items that are not only relevant but also valuable, such as by determining the detection rate with a focus on the detection of the fraud amount in the test data set. Thereafter, once the models are sufficiently accurate, those models may be selected for deployment, such as to allow, decline, or delay transactions, e.g., for further evaluation of potential fraud.

At step 618, model packaging is performed. During model packaging, the cluster-specific ML models may be stored in a containerized environment that facilitates efficient management and deployment of ML models. The package or container for an ML model may correspond to an executable container that includes everything needed to run the ML model (e.g., code, libraries, etc.). As such, model packaging and containerization may provide an encapsulation of the model along with the dependencies from the underlying training data, features, and modeling, which may be deployed in different computing environments.

As discussed above and further emphasized here, FIGS. 1-6 are merely examples of fraud reporting system 120 and corresponding methods for ML clustering of training data for customized and tailored ML model training, which said examples should not be used to unduly limit the scope of the claims. One of ordinary skill in the art would recognize many variations, alternatives, and modifications available at any time in the art, which may be used with or in place of the foregoing description based on the guidance provided by this application.

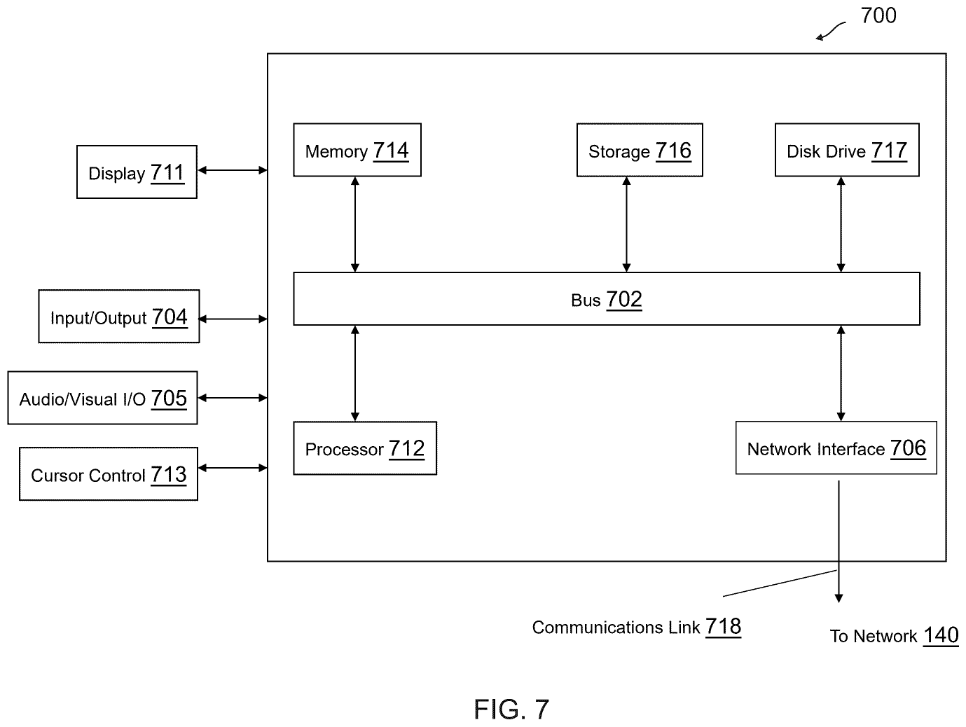

FIG. 7 is a block diagram of a computer system 700 suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 700 in a manner as follows.

Computer system 700 includes a bus 702 or other communication mechanism for communicating information data, signals, and information between various components of computer system 700. Components include an input/output (I/O) component 704 that processes a user action, such as selecting keys from a keypad/keyboard, selecting one or more buttons, image, or links, and/or moving one or more images, etc., and sends a corresponding signal to bus 702. I/O component 704 may also include an output component, such as a display 711 and a cursor control 713 (such as a keyboard, keypad, mouse, etc.). An optional audio/visual input/output component 705 may also be included to allow a user to use voice for inputting information by converting audio signals. Audio/visual I/O component 705 may allow the user to hear audio, and well as input and/or output video. A transceiver or network interface 706 transmits and receives signals between computer system 700 and other devices, such as another communication device, service device, or a service provider server via network 140. In one embodiment, the transmission is wireless, although other transmission mediums and methods may also be suitable. One or more processors 712, which can be a micro-controller, digital signal processor (DSP), or other processing component, processes these various signals, such as for display on computer system 700 or transmission to other devices via a communication link 718. Processor(s) 712 may also control transmission of information, such as cookies or IP addresses, to other devices.

Components of computer system 700 also include a system memory component 714 (e.g., RAM), a static storage component 716 (e.g., ROM), and/or a disk drive 717. Computer system 700 performs specific operations by processor(s) 712 and other components by executing one or more sequences of instructions contained in system memory component 714. Logic may be encoded in a computer readable medium, which may refer to any medium that participates in providing instructions to processor(s) 712 for execution. Such a medium may take many forms, including but not limited to, non-volatile media, volatile media, and transmission media. In various embodiments, non-volatile media includes optical or magnetic disks, volatile media includes dynamic memory, such as system memory component 714, and transmission media includes coaxial cables, copper wire, and fiber optics, including wires that comprise bus 702. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 700. In various other embodiments of the present disclosure, a plurality of computer systems 700 coupled by communication link 718 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Although illustrative embodiments have been shown and described, a wide range of modifications, changes and substitutions are contemplated in the foregoing disclosure and in some instances, some features of the embodiments may be employed without a corresponding use of other features. One of ordinary skill in the art would recognize many variations, alternatives, and modifications of the foregoing disclosure. Thus, the scope of the present application should be limited only by the following claims, and it is appropriate that the claims be construed broadly and in a manner consistent with the scope of the embodiments disclosed herein.

What is claimed is:

1. A machine learning (ML) system configured to intelligently cluster training data into separate training data sets for customized ML model training, the ML system comprising:
a processor and a non-transitory computer readable medium operably coupled thereto, the computer readable medium comprising a plurality of instructions stored in association therewith that are accessible to, and executable by, the processor, to perform model training operations which comprise:
accessing the training data, wherein each of the plurality of ML models are to be trained on the separate training data sets from the training data, and wherein the training data corresponds to individual data records each having a plurality of characteristics;
determining a set of features used for the customized ML model training, wherein the set of features are associated with the plurality of characteristics;
clustering the training data into the separate training data sets according to the set of features and the plurality of characteristics using an ML clustering technique;
outputting the separate training data sets resulting from the clustering to the customized ML model training, wherein the separate training data sets are each associated with one or more of the set of features shared by corresponding ones of the individual data records clustered for each of the separate training data sets;
training the plurality of ML models using the customized ML model training and the separate training data sets;
packaging the plurality of ML models in individual data containers having computing code executable by an ML data processing platform for processing real-time data using the plurality of ML models; and
configuring the ML data processing platform with the individual data containers, wherein the ML data processing platform is configured to associate the real-time data with a corresponding one of the plurality of ML models based on the one or more of the set of features shared by the corresponding ones of the individual data records in each of the separate training data sets.

2. The ML system of claim 1, wherein the training data comprises a transaction data set including fraud data for one or more fraudulent transactions in the transaction data set, and wherein the plurality of characteristics of the transaction data set include static characteristics associated with customer data and non-static characteristics associated with valid transactions and the one or more fraudulent transactions in the transaction data set.

3. The ML system of claim 1, wherein, before clustering the training data, the model training operations comprise:
creating a training data container for the training data based on the set of features associated with the plurality of characteristics,
wherein the clustering comprises:
generating a plurality of clusters of the individual data records based on values for the plurality of characteristics in the individual data records and the set of features, wherein the plurality of clusters are generated based on a cluster center and a cluster distance score from the cluster center for each of the individual data records; and
assigning each of the plurality of clusters to one of the separate training data sets based on cluster membership of the individual data records in each of the plurality of clusters.

4. The ML system of claim 3, wherein the generating the plurality of clusters uses a K-means clustering operation with an Elbow Method technique for testing a number of the plurality of clusters based on the cluster center, the cluster distance score, and the cluster membership of each of the plurality of clusters.

5. The ML system of claim 1, wherein the training the plurality of ML models comprises:
assigning an individual model training process of the customized ML model training to each of the separate training data sets;
selecting relevant features for each of the separate training data sets based on different ones of the set of features indicative of an activity for detection by a corresponding one of the plurality of ML models; and
training each of the plurality of ML models using the individual model training process and the relevant features.

6. The ML system of claim 1, wherein the training data is associated with past transactions and the plurality of ML models are trained for fraud detection based on the past transactions, and wherein, after configuring the ML data processing platform, the ML data processing platform is configured to assign new transactions to one of the plurality of ML models based on new transaction characteristics of each of the new transactions and to determine whether the new transaction is indicative of fraud based on the one of the plurality of ML models assigned to the new transaction.

7. The ML system of claim 1, wherein the customized ML model training uses an XGBoost model training technique for the plurality of ML models.

8. The ML system of claim 1, wherein, before the clustering, the model training operations further comprise:
performing one or more of a data filtration process, an exploratory data analysis process, a data enrichment process, a fraud enrichment process, a feature selection process, or a data preparation process on the separate training data sets.

9. The ML system of claim 1, wherein, before the clustering, the model training operations further comprise:
performing a data collection of the training data from an object storage service, wherein the object storage service stores the individual data records for a plurality of transaction processed by one or more entities associated with the ML data processing platform, and wherein the ML data processing platform comprises a fraud detection engine associated with an entity that processed the plurality of transactions.

10. A method to intelligently cluster training data into separate training data sets for customized machine learning (ML) model training for an ML system, the method comprising:
accessing the training data, wherein each of the plurality of ML models are to be trained on the separate training data sets from the training data, and wherein the training data corresponds to individual data records each having a plurality of characteristics;
determining a set of features used for the customized ML model training, wherein the set of features are associated with the plurality of characteristics;
clustering the training data into the separate training data sets according to the set of features and the plurality of characteristics using an ML clustering technique;
outputting the separate training data sets resulting from the clustering to the customized ML model training, wherein the separate training data sets are each associated with one or more of the set of features shared by corresponding ones of the individual data records clustered for each of the separate training data sets;
training the plurality of ML models using the customized ML model training and the separate training data sets;
packaging the plurality of ML models in individual data containers having computing code executable by an ML data processing platform for processing real-time data using the plurality of ML models; and
configuring the ML data processing platform with the individual data containers, wherein the ML data processing platform is configured to associate the real-time data with a corresponding one of the plurality of ML models based on the one or more of the set of features shared by the corresponding ones of the individual data records in each of the separate training data sets.

11. The method of claim 10, wherein the training data comprises a transaction data set including fraud data for one or more fraudulent transactions in the transaction data set, and wherein the plurality of characteristics of the transaction data set include static characteristics associated with customer data and non-static characteristics associated with valid transactions and the one or more fraudulent transactions in the transaction data set.

12. The method of claim 10, wherein, before clustering the training data, the method further comprises:
creating a training data container for the training data based on the set of features associated with the plurality of characteristics,
wherein the clustering comprises:
generating a plurality of clusters of the individual data records based on values for the plurality of characteristics in the individual data records and the set of features, wherein the plurality of clusters are generated based on a cluster center and a cluster distance score from the cluster center for each of the individual data records; and
assigning each of the plurality of clusters to one of the separate training data sets based on cluster membership of the individual data records in each of the plurality of clusters.

13. The method of claim 12, wherein the generating the plurality of clusters uses a K-means clustering operation with an Elbow Method technique for testing a number of the plurality of clusters based on the cluster center, the cluster distance score, and the cluster membership of each of the plurality of clusters.

14. The method of claim 10, wherein the training the plurality of ML models comprises:
assigning an individual model training process of the customized ML model training to each of the separate training data sets;
selecting relevant features for each of the separate training data sets based on different ones of the set of features indicative of an activity for detection by a corresponding one of the plurality of ML models; and
training each of the plurality of ML models using the individual model training process and the relevant features.

15. The method of claim 10, wherein the training data is associated with past transactions and the plurality of ML models are trained for fraud detection based on the past transactions, and wherein, after configuring the ML data processing platform, the ML data processing platform is configured to assign new transactions to one of the plurality of ML models based on new transaction characteristics of each of the new transactions and to determine whether the new transaction is indicative of fraud based on the one of the plurality of ML models assigned to the new transaction.

16. The method of claim 10, wherein the customized ML model training uses an XGBoost model training technique for the plurality of ML models.

17. The method of claim 10, wherein, before the clustering, the method further comprises:
performing one or more of a data filtration process, an exploratory data analysis process, a data enrichment process, a fraud enrichment process, a feature selection process, or a data preparation process on the separate training data sets.

18. The method of claim 10, wherein, before the clustering, the method further comprises:
performing a data collection of the training data from an object storage service, wherein the object storage service stores the individual data records for a plurality of transaction processed by one or more entities associated with the ML data processing platform, and wherein the ML data processing platform comprises a fraud detection engine associated with an entity that processed the plurality of transactions.

19. A non-transitory computer-readable medium having stored thereon computer-readable instructions executable to intelligently cluster training data into separate training data sets for customized machine learning (ML) model training for an ML system, the computer-readable instructions executable to perform model training operations which comprise:
accessing the training data, wherein each of the plurality of ML models are to be trained on the separate training data sets from the training data, and wherein the training data corresponds to individual data records each having a plurality of characteristics;
determining a set of features used for the customized ML model training, wherein the set of features are associated with the plurality of characteristics;
clustering the training data into the separate training data sets according to the set of features and the plurality of characteristics using an ML clustering technique;
outputting the separate training data sets resulting from the clustering to the customized ML model training, wherein the separate training data sets are each associated with one or more of the set of features shared by corresponding ones of the individual data records clustered for each of the separate training data sets;
training the plurality of ML models using the customized ML model training and the separate training data sets;
packaging the plurality of ML models in individual data containers having computing code executable by an ML data processing platform for processing real-time data using the plurality of ML models; and
configuring the ML data processing platform with the individual data containers, wherein the ML data processing platform is configured to associate the real-time data with a corresponding one of the plurality of ML models based on the one or more of the set of features shared by the corresponding ones of the individual data records in each of the separate training data sets.

20. The non-transitory computer-readable medium of claim 19, wherein the training data comprises a transaction data set including fraud data for one or more fraudulent transactions in the transaction data set, and wherein the plurality of characteristics of the transaction data set include static characteristics associated with customer data and non-static characteristics associated with valid transactions and the one or more fraudulent transactions in the transaction data set.
